(19) United States
(12) Patent Application Publication
(10) Pub. No.: US 2004/0186967 A1
(43) Pub. Date: Sep. 23, 2004

(54) Free pointer pool implementation

(76) Inventor: Anupam Anand, Santa Clara, CA (US)

Correspondence Address: MCANDREWS HELD & MALLOY, LTD, 500 WEST MADISON STREET, SUITE 3400, CHICAGO, IL, 60661

(21) Appl. No.: 10/726,342

(22) Filed: Dec. 3, 2003

Related U.S. Application Data
(63) Continuation-in-part of application No. 10/389,922, filed on Mar. 18, 2003.

(51) Int. Cl. G06F 12/00

(52) U.S. Cl. 711/156

(57) ABSTRACT

A system and method for managing memory. A memory is parsed into memory blocks of memory segments. A logic circuit is associated with a memory block. The logic circuit has a first state when a memory segments in the associated memory block is available for data storage. Aspects of the invention may include a second logic circuit that is associated with a memory segment in a memory block. The second logic circuit has a first state when the associated memory segment is available for data storage. Aspects of the invention also include utilizing the first and second logic circuits for memory management.

### CROSS-REFERENCE TO RELATED APPLICATIONS/INCORPORATION BY REFERENCE

This application is a continuation-in-part of co-pending U.S. patent application Ser. No. 10/389,922, filed Mar. 18, 2003, which is hereby incorporated herein by reference in its entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### FIELD OF THE INVENTION

The present invention relates generally to memory management. More specifically, the present invention relates to a free-pointer-pool implementation for memory management.

### BACKGROUND OF THE INVENTION

In many digital systems that utilize memory, as memory is allocated and de-allocated over time, the memory becomes fragmented, and in some cases prohibitively fragmented. For example, in communication packet-switching systems, packets may have various different priorities, so the packets are not removed from the memory in the same order as the packets are placed in the memory. Over time, the memory utilization in such a system may appear almost random.

Memory, in such a fragmented state, is cumbersome to utilize efficiently. When the system needs to store data, the system must first find an available memory segment in the fragmented memory and then store the data. This memory-finding activity is potentially time-consuming.

One solution to the problem is to implement a free-pointer-pool utilizing a First-In-First-Out (FIFO) buffer. Such a free-pointer-pool FIFO buffer includes a list of memory pointers that point to memory segments in the memory that are available for data storage. In such an implementation, when the system needs to store data in a memory segment, the system obtains a memory segment pointer from the free-pointer-pool FIFO, stores the data in the memory segment pointed to by the memory segment pointer, and removes the memory segment pointer from the free-pointer-pool FIFO. When the system decides to de-allocate a memory segment, making the memory segment available for subsequent data storage, the system may simply place a memory pointer to the memory segment back in the free-pointer-pool FIFO.

The free-pointer-pool FIFO discussed above offers a time-efficient solution to the memory management problem. When the system needs to utilize a memory segment for data storage, the system quickly obtains a pointer to an available memory segment from the free-pointer-pool FIFO. The FIFO buffer implementation of the free-pointer-pool, however, achieves temporal efficiency at the expense of spatial efficiency. That is, while the FIFO buffer offers a time-efficient solution to allocating and de-allocating memory from a fragmented memory, the FIFO buffer requires a substantial amount of memory to implement.

To develop an understanding of the extent of the free-pointer-pool FIFO buffer spatial inefficiency, consider a system that has a memory of 4K (4096) memory segments. The address of each segment is at least twelve bits long. On system reset, every segment of the memory may be available for data storage. Accordingly, to contain a pointer to all available memory segments, the corresponding free-pointer-pool FIFO buffer must be 4K pointers deep and 12 bits wide. Further, the size of the free-pointer-pool FIFO buffer grows exponentially as the managed memory grows linearly. For example, doubling the exemplary managed memory size to 8K increases the depth of the free-pointer-pool FIFO buffer to 8K and also increases the width of the buffer to 13 bits.

The memory requirements of a free-pointer-pool FIFO buffer may quickly become prohibitively large, particularly in systems with a relatively finite amount of space, such as, for example, an integrated circuit, multi-chip module, or circuit board level system.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and method are provided for managing memory. The memory is parsed into memory blocks of memory segments. A first logic circuit is associated with a first memory block of the memory, and additional logic circuits may be associated with additional memory blocks of the memory. The first logic circuit may, for example, have a state indicative of the associated memory block having a memory segment that is available for data storage. A second logic circuit is associated with a first memory segment in the first memory block, and additional logic circuits may be associated with additional memory segments in the first memory block and in the memory in general. The second logic circuit may, for example, have a state indicative of the associated memory segment being available for data storage.

In accordance with various aspects of the present invention, logic circuits may be arranged to represent groups of flags, with one group of flags associated with respective memory blocks and another group of flags associated with memory segments. The state of a memory block flag may be representative of the associated memory block having a memory segment available for data storage. The state of a memory segment flag may be representative of the associated memory segment being available for data storage. Aspects of the present invention may also include various logic circuits for utilizing and maintaining the groups of flags as corresponding memory blocks and memory segments are allocated and de-allocated.

Various aspects of the present invention may also include methods for memory management. The methods may include analyzing a group of flags associated with memory blocks to identify a memory block that has at least one memory segment available for storage. The methods may include analyzing a group of flags associated with memory segments in the memory block to identify a memory segment that is available for data storage. The methods may include utilizing the identified memory segment. The methods may further include maintaining the groups of flags as memory segments are allocated and de-allocated.

These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a diagram illustrating a flag-based free-pointer-pool, in accordance with various aspects of the present invention.

FIG. 2 is a diagram illustrating a bitmap-based free-pointer-pool, in accordance with various aspects of the present invention.

FIG. 3 is a diagram showing a system utilizing a flag-based free-pointer-pool for memory management, in accordance with various aspects of the present invention.

FIG. 4 is a diagram showing a system utilizing a bitmap-based free-pointer-pool for memory management, in accordance with various aspects of the present invention.

FIG. 5 is a diagram illustrating utilization of a bitmap-based free-pointer-pool for memory allocation, in accordance with various aspects of the present invention.

FIG. 6 is a diagram illustrating utilization of a bitmap-based free-pointer-pool for memory allocation, in accordance with various aspects of the present invention.

FIG. 7 is a diagram illustrating bitmap-to-memory-address conversion, in accordance with various aspects of the present invention.

FIG. 8 is a diagram illustrating utilization of a bitmap-based free-pointer-pool for memory de-allocation, in accordance with various aspects of the present invention.

FIG. 9 is a diagram illustrating utilization of a bitmap-based free-pointer-pool for memory de-allocation, in accordance with various aspects of the present invention.

FIG. 10 is a diagram showing a method for utilizing a flag-based free-pointer-pool for memory allocation, in accordance with various aspects of the present invention.

FIG. 11 is a diagram showing a method for utilizing a flag-based free-pointer-pool for memory de-allocation, in accordance with various aspects of the present invention.

FIG. 12 is a diagram showing a method for utilizing a bitmap-based free-pointer-pool for memory allocation, in accordance with various aspects of the present invention.

FIG. 13 is a diagram showing a method for utilizing a bitmap-based free-pointer-pool for memory de-allocation, in accordance with various aspects of the present invention.

### DETAILED DESCRIPTION OF THE INVENTION

FIG. 1 is a diagram illustrating a flag-based free-pointer-pool 100, in accordance with various aspects of the present invention. A memory 110 includes first memory block 120 and a second memory block 130. The first memory block 120 includes a respective first memory segment 121, second memory segment 122, third memory segment 123 and fourth memory segment 124. The second memory block 130 similarly includes a respective first memory segment 131, second memory segment 132, third memory segment 133 and fourth memory segment 134.

The free-pointer-pool 100 includes a first set of flags 140 and a second set of flags 150. The first set of flags 140 includes a first flag 141 that corresponds to the first memory segment 121 of the first memory block 120, a second flag 142 that corresponds to the second memory segment 122 of the first memory block 120, a third flag 143 that corresponds to the third memory segment 123 of the first memory block 120, and a fourth flag 144 that corresponds to the fourth memory segment 124 of the first memory block. Similarly, the first set of flags 140 includes a fifth flag 145 that corresponds to the first memory segment 131 of the second memory block 130, a sixth flag 146 that corresponds to the second memory segment 132 of the second memory block 130, a seventh flag 147 that corresponds to the third memory segment 133 of the second memory block 130, and an eighth flag 148 that corresponds to the fourth memory segment 134 of the second memory block 130. The second set of flags 150 includes a first flag 151 that corresponds to the first memory block 120 and a second flag 152 that corresponds to the second memory block 130.

The first set of flags 140 thus contains a flag 141-148 corresponding to each memory segment 121-124, 131-134 in the memory 110. These memory segment flags 141-148 indicate whether each flag's corresponding memory segment 121-124, 131-134 is available for data storage. For example, the first memory segment flag 141 corresponds to the first memory segment 121 of the first memory block 120. As illustrated in FIG. 1, the first memory segment flag 141 contains an indication (e.g., “No”) to indicate that the first memory segment 121 of the first memory block 120 is not available for data storage. By comparison, the sixth memory segment flag 146 contains an indication (e.g., “Yes”) to indicate that the second memory segment 132 of the second memory block 130 is available for data storage.

The second set of flags 150 contains a flag 151, 152 corresponding to each memory block 120, 130. These memory block flags 151, 152 indicate whether each flag's corresponding memory block 120, 130 contains a memory segment that is available for data storage. For example, the first block flag 151 corresponds to the first memory block 120. The first block flag 151 contains an indication (e.g., “No”) to indicate that none of the memory segments 121-124 in the first memory block 120 are available for storage. By comparison, the second block flag 152, which corresponds to the second memory block 130, contains an indication (e.g., “Yes”) to indicate that at least one of the memory segments 131-134 in the second memory block 130 (namely the second memory segment 132) is available for data storage.

Note that the “Yes” and “No” indications are merely illustrative, and the flags, in practice, may indicate memory availability in a variety of ways. For example, the flags may have additional information, such as the number of available memory segments in a memory block or an offset to a next available memory segment or block. Accordingly, the illustrative “Yes” and “No” indications are, by no means, to be construed as limiting the scope of various aspects of the present invention.

An alternative way to view the second set of flags 150 is to view the flags 151-152 of the second set of flags 150 as corresponding to subsets of the first set of flags 140. Since the first four flags 141-144 of the first set of flags 140 correspond to the four memory segments 121-124 of the first memory block 120, one may view the first flag 151 of the second set of flags 150 as indicative of the states of the first four flags 141-144 of the first set of flags 140 rather than as directly indicative of the availability of the four memory segments 121-124 of the first memory block 120. Similarly, one may view the second flag 152 of the second set of flags 150 as indicative of the states of the last four flags 145-148 of the first set of flags 140 rather than as directly indicative of the availability of the four memory segments 131-134 of the second memory block 130.

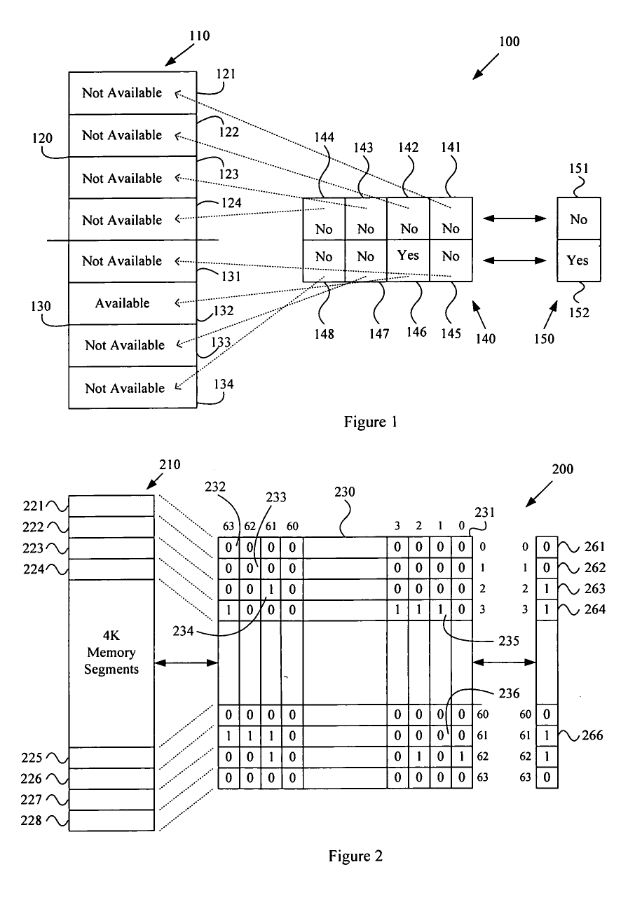

The flags 141-148 of the first set of flags 140 and the flags 151-152 of the second set of flags 150 may take many forms. For example, each flag may be implemented with a single logic bit or with multiple logic bits. The flags may be implemented in hardware or software. The flags may be implemented in volatile or non-volatile memory. The flags may be implemented in the same memory device as the memory 110, in a dedicated memory device, or in on-board memory for a processor or microcontroller. To develop a better understanding of a one-bit implementation of the flags, consider the bit-based free-pointer-pool 200 illustrated in FIG. 2.

FIG. 2 is a diagram illustrating a bitmap-based free-pointer-pool 200, in accordance with various aspects of the present invention. A memory 210 having 4K (4096) memory segments for data storage is logically sectioned into 64 blocks of memory segments (e.g., memory blocks 221-228), with each memory block having 64 respective memory segments. For example, the first memory block 221 includes 64 respective memory segments, and the sixty-third memory block 227 includes 64 respective memory segments.

The bitmap-based free-pointer-pool 200 includes a first bitmap 230 and a second bitmap 260. The first bitmap 230, which may also be referred to herein as the “memory segment bitmap 230,” includes segment bit-flags corresponding to each of the 4K memory segments in the memory 210. For example a first segment bit-flag 231 corresponds to the first memory segment of the first memory block 221 of the memory 210, and a sixty-fourth segment bit-flag 232 corresponds to the sixty-fourth memory segment in the first memory block 221 of the memory 210. Similarly, as will be referenced in later examples, a 127^{th} segment bit-flag 233 corresponds to the 127^{th} memory segment of the memory 210, which is also the sixty-third memory segment of the second memory block 221 of the memory 210; a 190^{th} segment bit-flag 234 corresponds to the 190^{th} memory segment of the memory 210, which is also the sixty-second memory segment of the third memory block 223 of the memory 210; a 194^{th} segment bit-flag 235 corresponds to the 194^{th} memory segment of the memory 210, which is also the second memory segment of the fourth memory block 224 of the memory 210; and a 3096^{th} segment bit-flag 236 corresponds to the 3096^{th} memory segment of the memory 210, which is also the second memory segment of the sixty-second memory block 226 of the memory 210.

The memory segment bit-flags (e.g., segment bit-flags 231-236) in the first bitmap 230 may indicate whether the corresponding memory segment in the memory 210 is available for data storage. A segment bit-flag with a logic state of “true” or “1” may, for example, indicate that the corresponding memory segment is available for data storage, and a segment bit-flag with a logic state of “false” or “0” may indicate, for example, that the corresponding memory segment is not available for data storage. Of course, the logic states indicative of “available” and “unavailable” may be inverted depending on a particular implementation of the bitmap 230.

The second bitmap 260, which may also be referred to herein as the “memory block bitmap 260,” includes block bit-flags corresponding to each of the sixty-four memory blocks (e.g., memory blocks 221-228) of the memory 210. For example, a first block bit-flag 261 corresponds to the first memory block 221 of the memory 210, and a second block bit-flag 262 corresponds to the second memory block 222 of the memory 210. Similarly, as will be referenced in later examples, a third block bit-flag 263 corresponds to the third memory block 223 of the memory 210, a fourth block bit-flag 264 corresponds to the fourth memory block 224 of the memory 210, and a sixty-second block bit-flag 266 corresponds to the sixty-second memory block 226 of the memory 210.

The block bit-flags (e.g., block bit-flags 261-264, 266) in the block bitmap 260 may indicate whether any of the memory segments in the corresponding memory blocks (e.g., memory blocks 221-224, 226) include memory segments that are available for storage. For example, assume that the logic state of “true” or “1” indicate that a corresponding memory block has an available memory segment. The first block bit-flag 261 is in a logic “0” state to indicate that the first memory block 221 does not contain any memory segments that are available for data storage. In other words, the first block bit-flag 261 having a logic “0” state is indicative of all of the segment bit-flags corresponding to memory segments in the first memory block 221 (i.e., those bit-flags illustrated in the first row of the segment bitmap 230) having a logic “0” state. Conversely, the third block bit-flag 263 has a logic “1” state to indicate that the third memory block 223 has at least one memory segment available for data storage. In the example shown, one such memory segment is the sixty-second memory segment of the third memory block 223, the availability of which is indicated by the 190^{th} segment bit-flag 234, which is the sixty-second segment bit-flag (right-to-left) in the third row on the segment bitmap 230.

An alternative way to view the block bit-flags in the block bitmap 260 is as a logical OR of all of the segment bit-flags corresponding to memory segments in the memory blocks that correspond to each of the block bit-flags. For example, one may view the logical state “0” of the first block bit-flag 261 as the logical OR of the sixty-four segment bit-flags corresponding to the memory segments in the first memory block 221 (i.e., the sixty-four segment bit-flags shown in the first row of the segment bitmap 230). Similarly, one may view the logical state “1” of the fourth block bit-flag 264 as the logical OR of the sixty-four segment bit-flags corresponding to the memory segments in the fourth memory block 224 (i.e., the sixty-four segment bit-flags shown in the fourth row of the segment bitmap 230). Note that the exemplary logical OR description is merely an example and should not be viewed as limiting the scope of various aspects of the invention in any way. As an example, using inverted logic and an AND-type logic function is well within the scope of various aspects of the present invention.

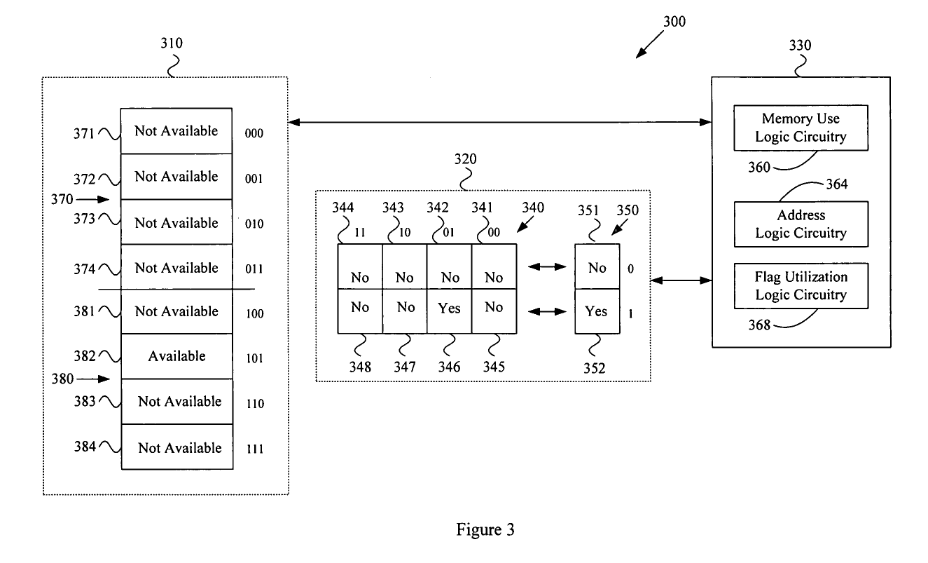

FIG. 3 is a diagram showing a system 300 utilizing a flag-based free-pointer-pool for memory management, in accordance with various aspects of the present invention. The system 300 includes a memory 310 and a flag-based free-pointer-pool 320. For illustrative purposes, the memory 310 and flag-based free-pointer-pool 320 are similar to those discussed earlier with respect to FIG. 1.

The system 300 includes logic circuitry 330 for managing the memory 310 and utilizing the flag-based free-pointer-pool 320. The logic circuitry 330 may include memory use logic circuitry 360 that utilizes the memory 310 by using memory management services provided by address logic circuitry 364 and flag utilization logic circuitry 368. The logic circuitry 330 may be implemented in a variety of ways, including, for example, in a hardware-intensive chip-based memory management unit, a programmed logic controller, or with a processor executing software or firmware instructions. A chip-based memory management unit may, for example, include the logic circuitry 330 and the flag-based free-pointer-pool 320 in one integrated package.

To illustrate exemplary operation of the logic circuitry 330, consider the logic circuitry 330 utilizing the flag-based free-pointer-pool 320 to perform a data store operation in the memory 310. When the system 300 performs a store operation, the memory use logic circuitry 360 may obtain an address of an available memory segment from the address logic circuitry 364 and the flag utilization logic circuitry 368. The memory use logic circuitry 360 may then perform the desired store operation at the addressed memory segment.

In supporting a store operation, the flag utilization logic circuitry 368 may identify one or more flags in the flag-based free-pointer-pool 320 that have states indicative of a memory segment being available for data storage. To efficiently identify an available memory segment, the flag utilization logic circuitry 368 may first identify a flag corresponding to a memory block of the memory 310 that contains an available memory segment. As addressed previously in the discussion of FIG. 1, each of the second set of flags 350 (also referred to herein as “block flags”) of the flag-based free-pointer-pool 320 may correspond to a respective block of memory segments in the memory 310. For example, the first block flag 351 of the set of block flags 350 may correspond to the first memory block 370 of the memory 310, and the second block flag 352 of the set of block flags 350 may correspond to the second memory block 380 of the memory 310.

The flag utilization logic circuitry 360 may thus identify a memory block in the memory 310 that has an available memory segment by identifying a block flag in the set of block flags 350 that has a logic state indicative of the block flag's corresponding memory block having an available memory segment. In the example shown in FIG. 3, the second block flag 352 of the set of block flags 350 has a logic state (e.g., “1”) indicative of the second memory block 380 having an available memory segment.

After identifying a block flag and corresponding memory block that has an available memory segment, the flag utilization logic circuitry 368 may efficiently analyze the first set of flags 340 (also referred to herein as “segment flags”) to identify an available memory segment within the identified memory block. As mentioned previously in the discussion of FIG. 1, each of the set of segment flags 340 of the flag-based free-pointer-pool 320 may correspond to a respective memory segment in the memory 310. Knowing the identity of a memory block in the memory 310 that has an available memory segment provides an opportunity for an efficient analysis of the set of segment flags 340.

For example, since the first block flag 351 of the set of block flags 350 has a logic state indicative of the first memory block 370 not having an available memory segment, the flag utilization logic circuitry 368 does not need to spend resources analyzing the segment flags 341-344 of the set of segment flags 340 that correspond to the memory segments 371-374 of the first memory block 370. In the example shown, if the flag utilization logic circuitry 368 determines that the second block flag 352 of the set of block flags 350 has a logic state indicative of the second memory block 380 of the memory 310 having an available memory segment, the flag utilization logic circuitry 368 need only consider the segment flags 345-348 in the set of segment flags 340 that correspond to the memory segments 381-384 of the second memory block 380.

In an exemplary implementation, the flag utilization logic circuitry 368 may use the known position of the identified block flag in the set of block flags 350 to index into the set of segment flags 340 and analyze one or more of the segment flags of the set of segment flags 340 at the indexed position. In the example illustrated, because the flag utilization logic circuitry 368 identified the second block flag 352 in the set of block flags 350, the flag utilization logic circuitry 368 may efficiently index to the second row of the set of segment flags 340 and analyze one or more of the segment flags 345-348 in the second row.

After the flag utilization logic circuitry 368 identifies a flag(s) corresponding to an available memory segment, the flag utilization logic circuitry 368 may update the state of the identified flag(s) to indicate that the corresponding memory segment is no longer available for data storage For example, the flag utilization logic circuitry 368 may set the state of the sixth segment flag 346 to “0.”

The flag utilization logic circuitry 368 may also determine if such a state update is necessary for the identified block flag in the set of block flags 350. The need for such an update depends on the availability of other memory segments in the memory block corresponding to the block flag. If a “store” operation, for example, consumed the last available memory segment in the corresponding memory block, then the flag utilization logic circuitry 368 should update the identified block flag in the set of block flags 350 to indicate that the corresponding memory block does not contain an available memory segment. In the example above, since the identified memory segment 382 was the last available memory segment in the second memory block 380, the flag utilization logic circuitry 368 should set the corresponding second block flag 352 of the set of block flags 350 to a logic state indicating that the second memory block 380 does not have an available memory segment (e.g., logic state “0”).

When the flag utilization logic circuitry 368 has identified the flag(s) corresponding to an available memory segment, the address logic circuitry 364 may convert the flag information provided by the flag utilization logic circuitry 368 to the memory address of the available memory segment.

The address logic circuitry 364 may, for example, utilize the position of the identified segment flag in the set of segment flags 340 and the position of the identified block flag in the set of block flags 350 to determine the memory segment address. For example, the address logic circuitry 364 may convert the position of the identified block flag in the set of block flags 350 to a most significant address portion. In the illustrated example, and as shown by the digits to the right of the set of block flags 350, the address logic circuitry 364 may convert the position of the first block flag 351 in the set of block flags 350 to a most significant address portion of “0” and the position of the second block flag 352 in the set of block flags 350 to a most significant address portion of “1.” In the example provided, the flag utilization logic circuitry 368 identified the second flag 352 of the set of block flags 350, thereby resulting in a most significant address portion of “1.”

The address logic circuitry 364 may likewise convert the position of the identified segment flag in the set of segment flags 340 to a least significant address portion. For example, the address logic circuitry 364 may convert the column position of the identified segment flag in the set of segment flags 340 to the least significant address portion. As illustrated above the set of segment flags 340, from right-to-left, a first column position 341, 345 may correspond to a least significant address portion of “00,” a second column position 342, 346 may correspond to a least significant address portion of “01,” a third column position 343, 347 may correspond to a least significant address portion of “10,” and a fourth column position 344, 348 may correspond to a least significant address portion of “11.” Continuing with the example previous, the flag utilization logic circuitry 368 identified the segment flag 346 in the second column (right-to-left) of the set of segment flags 340, which corresponds to a least significant address portion of “01.”

Once determining the most significant address portion for the memory segment based on the position of the identified block flag in the set of block flags 350 and the least significant address portion for the memory segment based on the column position of the identified segment flag in the set of segment flags 340, the address logic circuitry 364 may combine the most and least significant address portions to form the complete address for the identified available memory segment. Continuing the example, combining the most significant address portion “1” with the least significant address portion “01” yields a complete memory address of “101” for the available memory segment, which matches the “101” address next to the “Available” memory segment 382 in the memory 310 shown in FIG. 3.

The previous example focused on a “store” situation, where the system 300 located an available memory segment and allocated that available memory segment for use. The system 300 may also perform a “memory-freeing” operation, thereby designating a memory segment as being available for future data storage (e.g., when the consumer of the memory segment no longer needs the memory segment). Further insight into various aspects of the present invention may be gained by considering the logic circuitry 330 performing an exemplary memory-freeing operation.

During a memory-freeing operation, the memory use logic circuitry 360 may, for example, provide the address of the memory segment being freed to the address logic circuitry 364. The address logic circuitry 364 may then, in turn, convert the memory segment address into flag positions in the set of segment flags 340 and the set of block flags 350. The address logic circuitry 364 may perform such conversions in a variety of ways. For example, the address logic circuitry 364 may parse the memory segment address into a most significant address portion and a least significant address portion. For illustrative purposes, consider the address logic circuitry 364 parsing a memory segment address of “010” into a most significant address portion of “0” and a least significant address portion of “10.”

The address logic circuitry 364 may then convert the most significant address portion to a flag position in the set of block flags 350. As shown in FIG. 3, a most significant address portion of “0” may correspond to the position of the first block flag 351 in the set of block flags 350, and a most significant address portion of “1” may correspond to the position of the second block flag 352 in the set of block flags 350. In the example, the address logic circuitry 364 converts the exemplary most significant address portion of “0” to the position of the first block flag 351 in the set of block flags 350. Relating the most significant address portion of “0” to the memory 310, the most significant address portion of “0” may correspond to the first memory block 370 in the memory 310.

Once the address logic circuitry 364 identifies the block flag, the flag utilization logic circuitry 368 may then ensure that the identified block flag has a logic state indicative of the corresponding memory block having a memory segment available for data storage.

The address logic circuitry 364 may also convert the least significant address portion to a flag position in the set of segment flags 340. For example, a least significant address portion of “00” may correspond to a position of column one (right-to-left) in the set of segment flags 340, a least significant address portion of “01” may correspond to a column two position, a least significant address portion of “10” may correspond to a column three position, and a least significant address portion of “11” may correspond to a column four position. In the example, the address logic circuitry 364 converts the least significant address portion of “10” to the position of the third column (right-to-left) of the set of segment flags 340, which corresponds to one the third and seventh segment flags 343, 347.

To determine the effective row of the segment flag, the address logic circuitry 364 may utilize the block flag position already calculated above, or alternatively the address logic circuitry 364 may determine the effective row of the segment flag in some other way. For example, the address logic circuitry 364 may utilize the position of the second block flag as an indication of the second row of the set of segment flags. In the example, the address logic circuitry 364 determines the second position of the identified block flag in the set of block flags corresponds to the second row of the set of segment flags, thus completing the identification of the seventh segment flag 347.

Once the address logic circuitry 364 identifies the segment flag, the flag utilization circuitry 368 may then ensure that the identified segment flag in the set of segment flags 350 has a logic state indicative of the corresponding memory segment being available for data storage (i.e., “freed”).

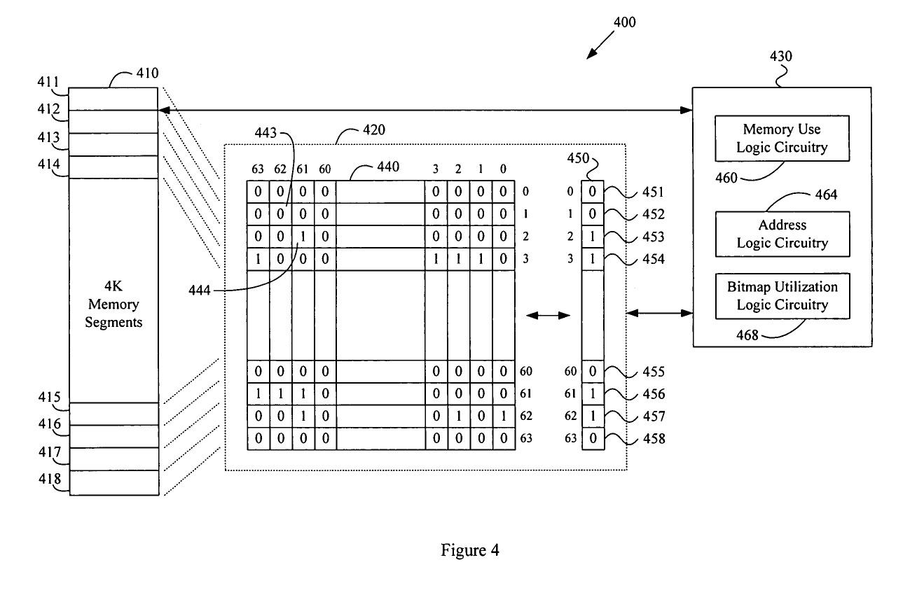

As mentioned previously, in at least one aspect of the present invention, the states of the segment and block flags may be single-bit logic states. FIG. 4 provides an exemplary system 400 utilizing a bitmap-based free-pointer-pool for memory management, in accordance with various aspects of the present invention. The system 400 includes a memory 410 and a bitmap-based free-pointer pool 420. For illustrative purposes, the memory 410 and bitmap-based free-pointer pool 420 are similar to those discussed earlier with respect to FIG. 2. The exemplary bitmap-based system 400 is similar in many ways to the exemplary flag-based system 300 illustrated in FIG. 3 and discussed previously.

The system 400 includes logic circuitry 430 for managing the memory 410 and utilizing the bitmap-based free-pointer-pool 420. The logic circuitry 430 may include memory use logic circuitry 460 that utilizes the memory 410 by using memory management services provided by address logic circuitry 464 and bitmap utilization logic circuitry 468. The logic circuitry 430 may be implemented in a variety of ways, including, for example, in a hardware-intensive chip-based memory management unit, a programmed logic controller, or with a processor executing software or firmware instructions. A chip-based memory management unit may, for example, include the logic circuitry 430 and the bitmap-based free-pointer-pool 420 in a single integrated package.

To illustrate exemplary operation of the logic circuitry 430, consider the logic circuitry 430 utilizing the bitmap-based free-pointer-pool 420 to perform a data store operation in the memory 410. When the system 400 performs a store operation, the memory use logic circuitry 460 may obtain an address of an available memory segment from the address logic circuitry 464 and the bitmap utilization logic circuitry 468. The memory use logic circuitry 460 may then perform the desired store operation at the addressed memory segment.

In supporting a store operation, the bitmap utilization logic circuitry 468 may identify one or more bits in the bitmap-based free-pointer-pool 420 that have states indicative of a memory segment being available for data storage. To efficiently identify an available memory segment, the bitmap utilization logic circuitry 468 may first identify a bit corresponding to a memory block of the memory 410 that contains an available memory segment. As addressed previously in the discussion of FIG. 2, each of the bits (also referred to herein as “block bits”) of the second bitmap 450 (also referred to herein as the “block bitmap”) may correspond to a respective block of memory segments in the memory 410. For example, the first block bit 451 of the block bitmap 450 may correspond to a first memory block 411 of the memory 410, the second block bit 452 of the block bitmap 450 may correspond to the second memory block 412 of the memory 410, the third block bit 453 of the block bitmap 450 may correspond to the third memory block 413 of the memory 410, and the sixty-third block bit 457 of the block bitmap 450 may correspond to the sixty-third memory block 417 of the memory 410.

The flag utilization logic circuitry 460 may thus identify a memory block in the memory 410 that has an available memory segment by identifying a block bit in the block bitmap 450 that has a logic state indicative of the block bit's corresponding memory block having an available memory segment. In the example shown in FIG. 4, the third block bit 453 of the block bitmap 450 has a logic state (e.g., “1”) indicative of the third memory block 413 having an available memory segment.

After identifying a block bit and corresponding memory block that has an available memory segment, the bitmap utilization logic circuitry 468 may efficiently analyze the second set of bits 440 (also referred to herein as the segment bitmap) to identify an available memory segment within the identified memory block. As mentioned previously in the discussion of FIG. 2, each bit (also referred to herein as a “segment bit”) of the segment bitmap 440 of the bitmap-based free-pointer-pool 420 may correspond to a respective memory segment in the memory 410. Knowing the identity of a memory block in the memory 310 that has an available memory segment provides an opportunity for an efficient analysis of the segment bitmap 440.

For example, since the first block bit 451 and second block bit 452 of the block bitmap 450 have logic states indicative of the first memory block 411 and second memory block 412 not having available memory segments, the bitmap utilization logic circuitry 468 does not need to spend resources analyzing the segment bits of the segment bitmap 440 that correspond to the memory segments in the first and second memory blocks 411-412 (i.e., for example, the segment bits in the first and second rows of the illustrated segment bitmap 420). In the example shown, if the bitmap utilization logic circuitry 468 determines that the third block flag 453 of the block bitmap 450 has a logic state indicative of the third memory block 413 of the memory 410 having an available memory segment, the bitmap utilization logic circuitry 468 need only consider one or more of the segment bits in the segment bitmap 440 that correspond to the memory segments of the third memory block 413 (i.e., the segment bits illustrated in the third row of the segment bitmap 440.

In one exemplary implementation, the bitmap utilization logic circuitry 468 may use the known position of the identified block bit in the block bitmap 450 to index into the segment bitmap 440 and analyze one or more of the segments bits of the segment bitmap 440 starting at the indexed position. In the example illustrated, because the bitmap utilization logic circuitry 468 identified the third block bit 453 in the block bitmap 450, the bitmap utilization logic circuitry 468 may efficiently index to the third row of the segment bitmap 440 and analyze one or more of the segment bits in the third row. Continuing with the example, the bitmap utilization logic circuitry 468 may identify the 190^{th} bit in the segment bitmap 440, which is the 62^{nd} bit (right-to-left) in the third row of the segment bitmap 440.

After the bitmap utilization logic circuitry 468 identifies the bit(s) corresponding to an available memory segment, the bitmap utilization logic circuitry 468 may update the states of the identified bit(s) to indicate that the corresponding memory segment is no longer available for data storage. For example, the bitmap utilization logic circuitry 468 may set the state of the 190^{th} segment bit 444 of the segment bitmap 440 to “0.”

The bitmap utilization logic circuitry 468 may also determine if such a state update is necessary for the identified block bit in the block bitmap 450. The need for such an update depends on the availability of other memory segments in the corresponding memory block. If the “store” operation consumed the last available memory segment in the corresponding block, then the bitmap utilization logic circuitry 468 should update the identified block bit in the block bitmap 450 to indicate that the corresponding memory block does not contain an available memory segment. In the example above, since the identified memory segment corresponding to the sixty-second bit 444 in the third row of the segment bitmap 440 was the last available memory segment in the third memory block 413, the flag utilization logic circuitry 468 should set the corresponding third block bit 453 of the block bitmap 450 to a logic state (e.g., “0”) indicating that the third memory block 413 does not have an available memory segment.

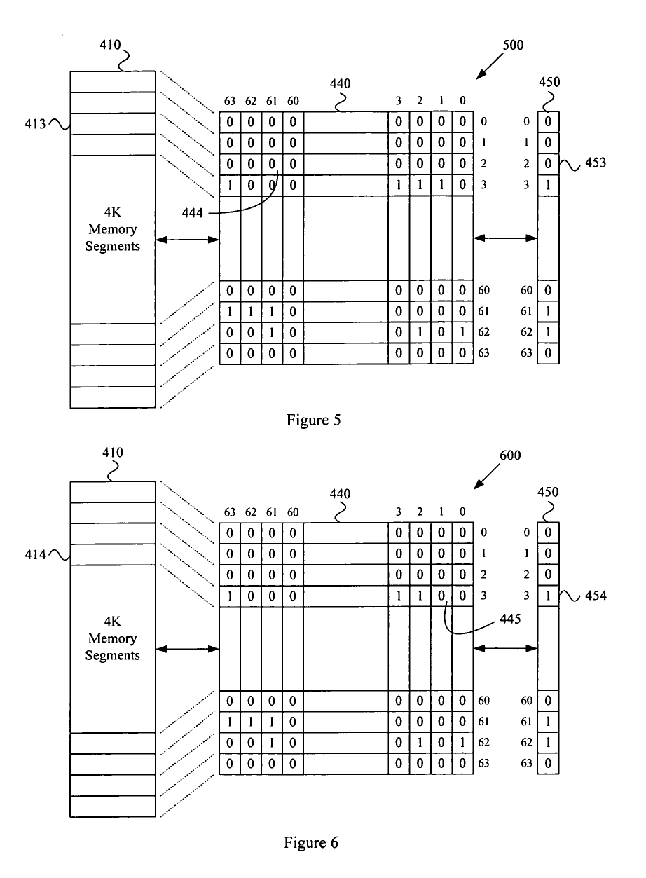

To illustrate the previously discussed example, refer to FIG. 5, which illustrates the previously described utilization of the bitmap-based free-point-pool 500, in accordance with various aspects of the present invention. FIG. 5 illustrates the block bitmap 450 and segment bitmap 440 after being updated as previously described. The 190^{th} segment bit (or sixty-second segment bit 444 (right-to-left) of the third row) of the segment bitmap 440 now has a “0” state to indicate that the corresponding memory segment is not available for data storage. Similarly, the third block bit 453 in the block bitmap 450 now has a “0” state to indicate that the third block 413 of the memory 410 has no memory segments available for data storage.

For further illustration of the previous discussion refer to FIG. 6, which is a diagram 600 illustrating utilization of a bitmap-based free-pointer-pool for memory allocation in accordance with various aspects of the present invention. FIG. 6 shows a situation where the state of a segment bit 445 has been cleared (e.g., set to a “0” state) to indicate that the corresponding memory segment is not available for data storage. However, the state of the fourth block bit 454 in the block bitmap 450 remains unchanged, because the memory block corresponding to the fourth block bit 454 still has at least one memory segment available for data storage, which is also indicated by segment bits in the fourth row of the segment bitmap 440 having states (e.g., “1”) indicating that corresponding memory segments in the fourth memory block 414 are still available for data storage.

Referring back to FIG. 4, when the bitmap utilization logic circuitry 468 has identified the bits corresponding to an available memory segment, the address logic circuitry 464 may convert bit information provided by the bitmap utilization logic circuitry 468 to the memory address of the available memory segment. The address logic circuitry 464 may, for example, utilize the position of the identified segment bit in the segment bitmap 440 and the position of the identified block bit in the block bitmap 450 to determine the memory segment address. For example, the address logic circuitry 464 may convert the position of the identified block bit in the block bitmap 450 to a most significant address portion and the position of the identified bit in the segment bitmap 440 to a least significant address portion.

In the illustrated example, and as shown by the digits to the left of the block bitmap 450, the address logic circuitry 464 may convert the position of the first block bit 451 in the block bitmap 450 to a most significant address portion of “0” (000000 binary), the position of the second block bit 452 in the block bitmap 450 to a most significant address portion of “1” (000001 binary) and the position of the third block bit 453 in the block bitmap 450 to a most significant address portion of “2” (000010 binary). In the example provided, the bitmap utilization logic circuitry 468 identified the third bit 453 of block bitmap 450, thereby resulting in a most significant address portion of “2” (000010 binary).

The address logic circuitry 464 may likewise convert the position of the identified segment bit in the segment bitmap 440 to a least significant address portion. For example, the address logic circuitry 464 may convert the column position of the identified segment bit in the segment bitmap 440 to the least significant address portion. As illustrated, from right-to-left, a first column position may correspond to a least significant address portion of “0” (000000 binary), a second column position may correspond to a least significant address portion of “1” (000001 binary), and a sixty-second column position may correspond to a least significant address portion of “62” (111101 binary). Continuing with the example, the bitmap utilization logic circuitry 468 identified the segment bit 444 in the sixty-second column (right-to-left) of the segment bitmap 440, which corresponds to a least significant address portion of “111101.”

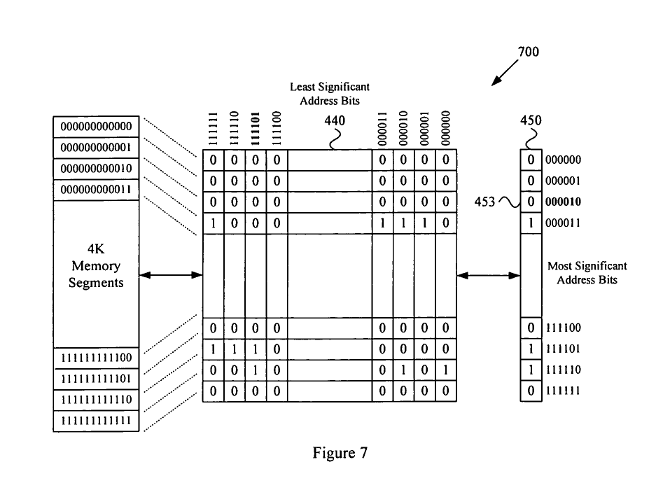

FIG. 7 contains a diagram 700 illustrating bitmap/memory-address conversion, in accordance with various aspects of the present invention. FIG. 7 illustrates the exemplary memory address determination described above. In particular, FIG. 7 illustrates the correlation between the third block bit 453 of the block bitmap 450 to the most significant address portion of “000010,” and the correlation between the sixty-second column (right-to-left) of the segment bitmap 440 and the least significant address portion of “111101.”

Referring back to FIG. 4, once determining the most significant address portion for the memory segment based on the position of the identified block bit in the block bitmap 450 and the least significant address portion for the memory segment based on the column position of the identified segment bit in the segment bitmap 440, the address logic circuitry 464 may combine the most and least significant address portions to form the complete address for the identified available memory segment. In the example, combining the most significant address portion “000010” with the least significant address portion “111101” yields a memory address of “000010111101” for the available memory segment.

The previous example focused on a “store” operation, where the system 400 located an available memory segment and allocated that available memory segment for use. The system 400 may also perform a “memory-freeing” operation, thereby designating a memory segment as being available for future data storage (e.g., when the consumer of the memory segment no longer needs the memory segment). Further insight into various aspects of the present invention may be gained by considering the logic circuitry 430 performing an exemplary memory-freeing operation.

During a memory-freeing operation, the memory use logic circuitry 460 may, for example, provide the address of the memory segment being freed to the address logic circuitry 464. The address logic circuitry 464 may then, in turn, convert the memory segment address into bit positions in the segment bitmap 440 and the block bitmap 450. The address logic circuitry 464 may perform the conversions in a variety of ways. For example, the address logic circuitry 464 may parse the memory segment address into a most significant address portion and a least significant address portion. For illustrative purposes, consider the address logic circuitry 464 parsing a memory segment address of “000001111110” into a most significant address portion of “000001” and a least significant address portion of “111110.”

The address logic circuitry 464 may then convert the most significant address portion into a bit position in the block bitmap 450. As shown in FIGS. 4 and 5, a most significant address portion of “000000” (0 decimal) may correspond to the position of the first block bit 451 in the block bitmap 450, and a most significant address portion of “000001” (1 decimal) may correspond to the position of the second block bit 452 in the block bitmap 450. In the example above, the address logic circuitry 464 converts the exemplary most significant address portion of “000001” to the position of the second block bit 452 in the block bitmap 450. The bit position in the block bitmap 450, for example, may also be used by the address logic circuitry 464 to identify the row of the segment bitmap 440 that contains the segment bit corresponding to the memory segment. Relating the most significant address portion of “000001” to the memory 410, the most significant address portion of “000001” may correspond to the second memory block 412 in the memory 410.

Once the address logic circuitry 464 identifies the block bit, the bitmap utilization logic circuitry 468 may then ensure that the identified block bit has a logic state indicative of the corresponding memory block having a memory segment available for data storage (e.g., “1”).

The address logic circuitry 464 may also convert the least significant address portion to a bit position in the segment bitmap 440. For example, a least significant address portion of “000000” (0 decimal) may correspond to a position of column one (right-to-left) in the segment bitmap 440, and a least significant address portion of “000001” (1 decimal) may correspond to a column two position. In the example above, the address logic circuitry 464 converts the least significant address portion of “111110” to the position of the sixty-third column (right-to-left). As discussed earlier, the address logic circuitry 464 may determine the row of the segment bitmap 440 as corresponding the previously-identified position of the block bit in the block bitmap 450.

Once the address logic circuitry 464 identifies the segment bit 443, the bitmap utilization circuitry 468 may then ensure that the identified segment bit 443 in the segment bitmap 440 has a logic state indicative of the corresponding memory segment being available for data storage (e.g., “1”).

FIG. 8 is a diagram 800 illustrating utilization of a bitmap-based free-pointer-pool for memory de-allocation, in accordance with various aspects of the present invention. FIG. 8, for example, highlights the memory-freeing example just discussed. The identified segment bit 443 in the sixty-third column of the second row of the segment bitmap 440 now has a state (e.g., “1”) indicative of the corresponding memory segment being available for data storage. Similarly, the second block bit 452 of the block bitmap 450 now has a state (e.g., “1”) indicative of the corresponding memory block having a memory segment that is available for data storage.

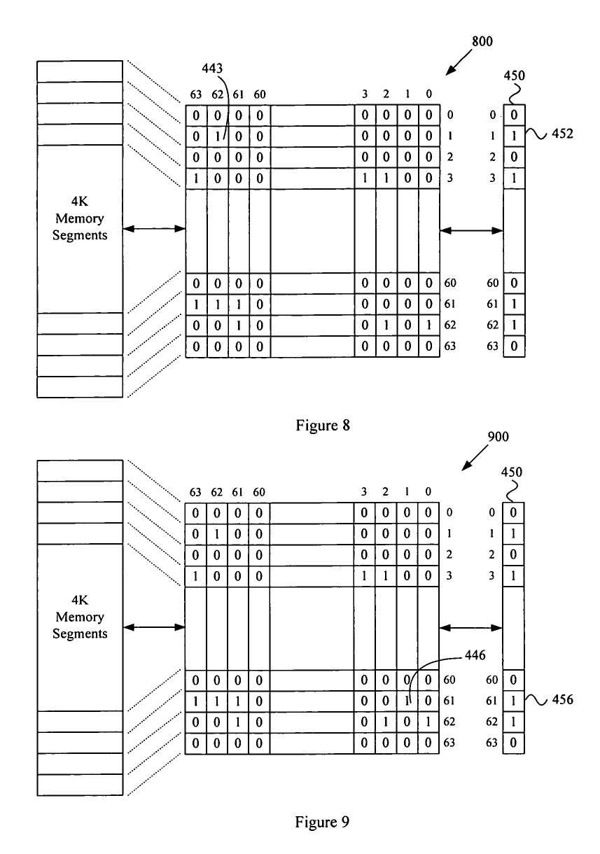

FIG. 9 is a diagram 900 illustrating utilization of a bitmap-based free-pointer-pool for memory allocation, in accordance with various aspects of the present invention. FIG. 9 illustrates a situation where the memory segment bit 446 has changed state to indicate that the corresponding memory segment is available for storage, but no state change occurred for the sixty-second block bit 456, since the sixty-second block 456 was already in the proper state prior to freeing the memory segment corresponding to the memory segment bit 446.

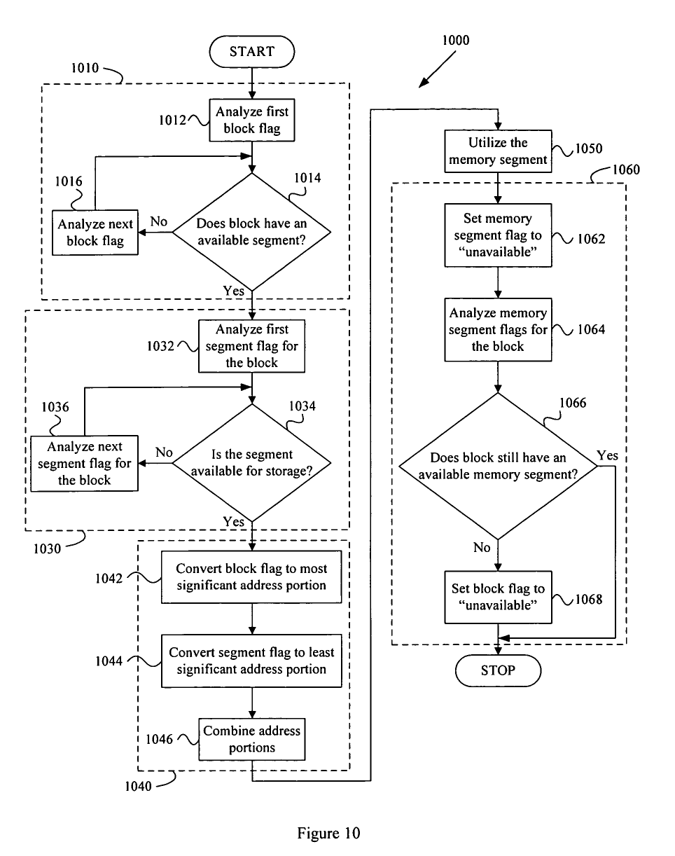

FIG. 10 shows a method for memory management 1000, in accordance with various aspects of the present invention. The method 1000 includes an initial non-illustrated step of parsing a managed memory into a set of memory blocks, and parsing each memory block into a set of memory segments. The method 1000 includes associating the memory blocks with a set of flags, which will also be referred herein to as “block flags.” Each block flag is indicative of a corresponding memory block having a memory segment that is available for data storage. The method 1000 also includes associating the memory segments of the memory with a second set of flags, which will also be referred to herein as “segment flags.” Each segment flag is indicative of a corresponding memory segment being available for data storage.

Note that the flags may take many forms, and the scope of the present invention is not to be limited to a particular form of flag. For example, as will be discussed in more detail later, a flag may be a single logic bit. The flag may also, for example, include multiple logical bits. The flag may also be implemented in a variety of circuit configurations, such as, for example, a stand-alone memory chip, a register in a signal processor, a section of the memory being managed, or any suitable digital or analog circuit. The flag may be in addressable memory accessible, for example, by a general-purpose microprocessor, or the flag may be in memory buried deep within a logic circuit and accessible only by specialized logic circuitry. The scope of the present invention should, by no means, be limited to a particular flag configuration or particular hardware or software flag implementation.

The method 1000 includes a step of identifying a block flag 1010 in the set of block flags that is indicative of the block flag's corresponding memory block having a memory segment available for data storage. The step of identifying a block flag 1010 may be accomplished in a variety of ways. For example, the step 1010 may identify the block flag using a processor executing software instructions to sequentially search through the set of block flags until finding a block flag with the desired state. Alternatively, for example, the step 1010 may identify the block flag by utilizing hardware specifically designed to efficiently identify the block flag. FIG. 10 illustrates exemplary sub-steps for the block flag identifying step 1010. Identifying a block flag 1010 may begin, for example, with a sub-step 1012 of analyzing information concerning the first block flag in the set of block flags to determine if the first block flag has a state indicative of the first block flag's corresponding memory block having a memory segment available for data storage.

At decision step 1014, if the retrieved block flag information does not indicate that its corresponding memory block has an available memory segment, then the block flag identifying step 1010 performs sub-step 1016 for analyzing information concerning a next block flag in the set of block flags. At decision step 1014, if the analyzed block flag information does not indicate that the block flag's corresponding memory block has an available memory segment, the step 1010 continues to sequence through the set of block flags until the step 1010 identifies the appropriate block flag.

If the analyzed block flag information indicates that the block flag's corresponding memory block contains an available memory segment, then the method 1000 proceeds to the next step 1030 of identifying a segment flag in the set of segment flags that indicates the segment flag's corresponding memory segment is available for data storage. Since the block flag identifying step 1010 previously identified a memory block that has an available memory segment, the segment flag identifying step 1030 need only analyze segment flags corresponding to memory segments in the previously-identified block.

Accordingly, the segment flag identifying step 1030 may next include a sub-step 1032 of analyzing segment flag information for the segment flag corresponding to the first memory segment in the previously-identified memory block to determine if the segment flag has a state indicative of the corresponding memory segment being available for data storage. As with the block flag identifying step 1010, the segment flag identifying step 1030 may be accomplished in a variety of ways. The segment flag identifying step 1030 illustrated in FIG. 10 is for illustrative purposes and is, by no means, to be construed as limiting the segment flag identifying step 1030 to a particular method or apparatus.

At the decision step 1034, if the retrieved segment flag information does not indicate that the segment flag's corresponding memory segment is available for memory, then the segment flag identifying step 1030 includes a sub-step 1036 that analyzes information concerning a next segment flag in the set of segment flags. If the analyzed segment flag information does not indicate that the segment flag's corresponding memory segment is available, the segment flag identifying step 1030 continues to sequence through the set of segment flags until the step 1030 identifies an appropriate segment flag.

If the analyzed segment flag information indicates that the segment flag's corresponding memory segment is available for storage, then the method 1000 performs the address-determining step 1040. The address-determining step 1040 determines an address of the available memory segment corresponding to the previously-identified segment flag and optionally, the previously-identified block flag. The address-determining step 1040 may be accomplished in a variety of ways. For example, various information may be contained in the segment or block flags that the step 1040 may utilize to calculate the segment address. Alternatively, for example, the step 1040 may convert the position of the identified segment flag in the set of segment flags to the address of the memory segment. Alternatively, for example, the step 1040 may also utilize the position of the identified block flag in the set of block flags to determine a portion of the available memory segment's address. The exemplary step 1040 illustrated in FIG. 10 is, by no means, to be construed as limiting the scope of various aspects of the present invention to a particular method or apparatus for determining the address of the available memory segment.

The illustrated address-determining step 1040 includes a sub-step 1042 that converts the position of the identified block flag in the set of block flags to a most significant address portion of the available memory segment. The sub-step 1042 may, for example, determine the most significant address portion to be the address of the memory block corresponding to the previously-identified block flag. In one aspect of the present invention, the address-determining step 1040 may simply set the most significant address portion of the available memory segment to be the index of the identified block flag in the set of block flags.

Next, the exemplary address-determining step 1040 includes a sub-step 1044 that converts the position of the previously-identified segment flag to a least significant portion of the available memory segment. Since the previous sub-step 1042 identified the most significant portion of the address as the base address of the memory block containing the available memory segment, the least significant address portion may be a segment offset into the memory block. During the illustrative segment flag identifying step 1030, the step 1030 sequenced through the segment flags that corresponded to memory segments in the previously-identified memory block. In identifying the appropriate segment flag, the segment flag identifying step 1030 may have, for example, identified the offset of the segment flag into the group of segment flags corresponding to the memory segments of the identified memory block. Accordingly, the offset of the segment flag into the group of segment flags analyzed in step 1030 may utilized as the least significant address portion of the available memory segment.

After determining a most significant address portion in sub-step 1042 and a least significant address portion in sub-step 1044, the address-determining step 1040 may combine the address portions in sub-step 1046 to yield the complete address of the available memory segment.

Knowing the address of the available memory segment, the method 1000 may then utilize the memory segment in sub-step 1050 by, for example, storing data in the available memory segment.

Now that the method 1000 has identified and utilized an available memory segment, the method 1000 may indicate that the identified memory segment is no longer available for memory storage. Accordingly, the method 1000 includes a flag-maintaining step 1060. The flag-maintaining step 1060 generally sets the states of the flags that were utilized to identify the available memory segment to indicate that the identified memory segment is no longer available. This flag-maintaining step 1060, of course, depends on the particular flag implementation, and the illustrated flag-maintaining step 1060 corresponds to the exemplary flag implementation previously discussed with regard to FIG. 10. Accordingly, the exemplary flag-maintaining step 1060 is, by no means, to be construed to limit the flag-maintaining step 1060 to a particular method or apparatus.

The flag-maintaining step 1060, in sub-step 1062, first sets the previously-identified segment flag to a state indicating that the corresponding memory segment is not available for data storage. Next, the flag-maintaining step 1060, in sub-step 1064, analyzes the states of one or more of the segment flags corresponding to memory segments in the previously-identified memory block. If, as determined in sub-step 1066, the memory block still contains at least one available memory segment, the flag-maintain step 1060 is complete. If, however, the memory block no longer contains an available memory segment, sub-step 1068 sets the state of the previously-identified block flag to indicate that the corresponding memory block does not contain an available memory segment.

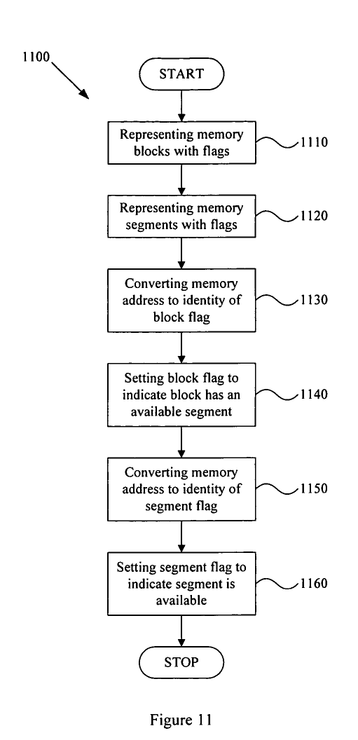

FIG. 10 illustrated an exemplary memory segment allocation and utilization method 1000, in accordance with various aspects of the present invention. For further understanding, FIG. 11 illustrates a method 1100 for utilizing a flag-based free-pointer-pool for memory de-allocation (or freeing) in accordance with various aspects of the present invention. As mentioned in the discussion regarding FIG. 10, the memory freeing method 1100 includes parsing the managed memory into blocks of memory segments. The method 1100 includes representing memory blocks 1110 with block flags and representing memory segments 1120 with segment flags.

In the illustrated memory-freeing method 1100, the address of the memory segment to be freed is known. The method 1100 includes a step 1130 that determines the block flag that corresponds to the memory block containing the designated memory segment. For example, the block-flag-determining sub-step 1130 may include converting a most significant portion of the memory segment address (e.g., the address of the memory block containing the memory segment) to the position of the corresponding block flag in the set of block flags.

Once the block flag determining step 1130 determines the appropriate block flag, the method 1100, in step 1140, sets the state of the block flag to indicate that the block corresponding to the block flag contains an available memory segment. Depending on the particular flag implementation, it may be most efficient to set the state of the block flag to the desired state, rather than determine whether the block flag already has the desired state prior to setting the flag state.

The method 1100 further includes a step 1150 that determines the segment flag that corresponds to the memory segment being freed. For example, the segment-flag-determining step 1150 may include converting the memory segment address to an index into the set of segment flags.

Once the method 1100 has identified, in step 1150, the segment flag corresponding to the memory segment being freed, the method 1100 may, at step 1160, set the segment flag 1160 to a state indicative of the designated segment being available for data storage.

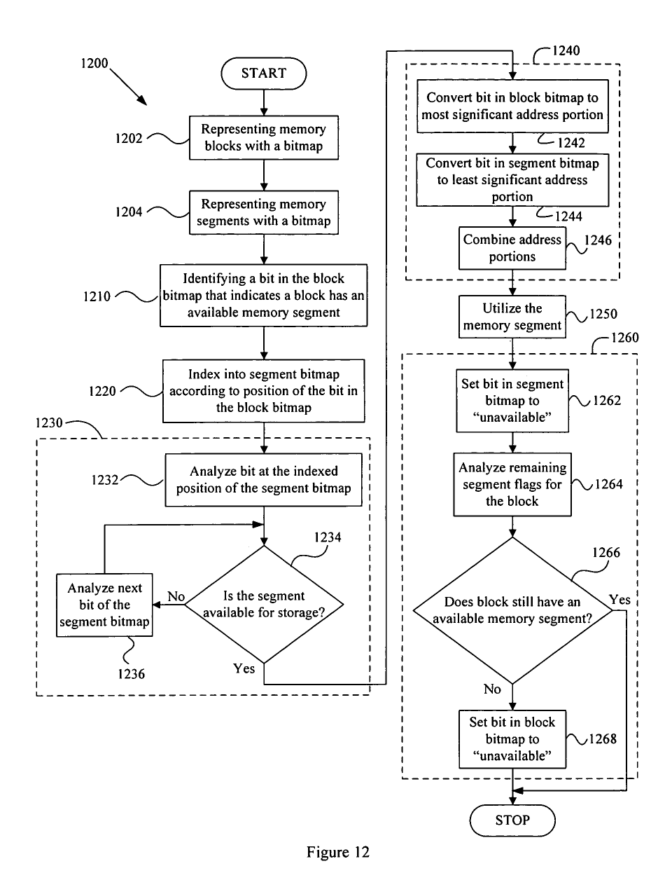

As mentioned previously, the block flags and segments flags may, for example, be single-bit flags. For illustrative purposes, FIG. 12 shows a method 1200 for utilizing a bitmap-based free-pointer-pool for memory allocation, in accordance with various aspects of the present invention.

The method 1200 includes an initial non-illustrated step of parsing a managed memory into a set of memory blocks, and parsing each memory block into a set of memory segments. The method 1200 includes associating 1202 the memory blocks with a bitmap of bit-flags, the bits of which will also be referred herein to as “block bits.” Each block bit is indicative of a corresponding memory block having a memory segment that is available for data storage. The method 1200 also includes associating 1204 the memory segments of the memory with a second bitmap, the bits of which will also be referred to herein as “segment bits.” Each segment bit is indicative of a corresponding memory segment being available for data storage.

The method 1200 includes a step 1210 of identifying a block bit in the block bitmap that is indicative of the block bit's corresponding memory block having a memory segment available for data storage. The step 1210 of identifying a block bit may be accomplished in a variety of ways. For example, the step 1210 may identify the block flag using a processor executing software instructions to sequentially search through the block bitmap until finding a block bit with the desired state. Alternatively, for example, the step 1210 may identify the block bit by utilizing hardware specifically designed to efficiently identify the block bit. The step 1210 may, for example, utilize sub-steps analogous to those illustrated in step 1010 of FIG. 10.

After locating a block bit in the block bitmap that indicates that the block bit's corresponding memory block contains an available memory segment, the method 1200, may perform a step 1220 of indexing into the segment bitmap in preparation for analyzing the segment bits that correspond to memory segments in the identified block. For example, in a view of the segment bitmap as a 2-dimensional matrix of bits having rows and columns, the step 1220 may index into a row of the segment bitmap corresponding to the index into the block bitmap at which the previously-identified block bit is located.

After indexing into the segment bitmap, the step 1230 may analyze the segment bitmap to identify a segment bit indicative of the segment bit's corresponding memory segment being available for data storage. The step 1230 may first, for example, analyze, at sub-step 1232, the bit indexed to at step 1220 to determine if that segment bit has the desired state. If sub-step 1234 determines that the segment bit does not have the desired state, the sub-step 1236 may index to and analyze a next segment bit in the segment bitmap. The operational loop formed by sub-steps 1234 and 1236 may then continue until the sub-step 1234 determines that the segment bit has a state indicative of the memory segment corresponding to the segment bit being available for data storage.

Having found a segment bit with the desired state, the method 1200 may perform step 1240, which determines the memory address for the memory segment corresponding to the previously-identified segment bit. As noted previously with regard to FIG. 10, a step of determining an address corresponding to identified flags (or bits) may be accomplished in a variety of ways, one example of which is illustrated in the address-determining step 1240

The address-determining step 1240 may, for example, include a sub-step 1242 that converts the position of the identified block bit in the block bitmap (or alternatively, the row of the segment bit in the segment bitmap) to a most significant address portion for the identified memory segment. The most significant address portion may be, for example, the base address of the memory block corresponding to the identified block bit.

Next, the exemplary address-determining step 1240 may include a sub-step 1244 that converts the position of the previously-identified segment bit to a least significant portion of the available memory segment. Since the previous sub-step 1242 identified the most significant portion of the address as the base address of the memory block containing the available memory segment, the least significant address portion may be a segment offset into the identified memory block. During the illustrative segment bit identifying step 1230, the step 1230 sequenced through the segment bits that corresponded to memory segments in the previously-identified memory block. In identifying the appropriate segment bit, the segment bit identifying step 1230 may have, for example, identified the offset of the segment bit into the group (or row) of segment bits corresponding to the memory segments of the identified memory block. Accordingly, the offset of the segment bit into the group (or row) of segment bits analyzed in step 1230 may be utilized as the least significant address portion of the available memory segment.

After determining a most significant address portion in sub-step 1242 and a least significant address portion in sub-step 1244, the address-determining step 1240 may combine the address portions in sub-step 1246 to form the complete address of the available memory segment.

Knowing the address of the available memory segment, the method 1200 may then utilize the memory segment in step 1250 by, for example, storing data in the available memory segment.

Now that the method 1200 has identified and utilized an available memory segment, the method 1200 should indicate that the identified memory segment is no longer available for memory storage. Accordingly, the method 1200 includes a bitmap-maintaining step 1260. The bitmap-maintaining step 1260 generally sets the states of the bits that were utilized to identify the available memory segment to indicate that the identified memory segment is no longer available. This bitmap-maintaining step 1260, of course, depends on the particular bitmap implementation, and the illustrated bitmap-maintaining step 1260 corresponds to the exemplary bit implementation previously discussed with regard to FIG. 12. Accordingly, the exemplary bitmap-maintaining step 1260 is, by no means, to be construed to limit the bitmap-maintaining step 1260 to a particular method or apparatus.

The bitmap-maintaining step 1260, in sub-step 1262, sets the previously-identified segment bit to a state indicating that the corresponding memory segment is not available for data storage. Next, the bitmap-maintaining step 1260, in sub-step 1264, analyzes the states of one or more of the segment bits corresponding to memory segments in the previously-identified memory block. If, as determined in sub-step 1266, the memory block still contains at least one available memory segment, the bitmap-maintaining step 1260 is complete. If, however, the memory block no longer contains an available memory segment, sub-step 1268 sets the state of the previously-identified block bit to indicate that the corresponding memory block does not contain an available memory segment.

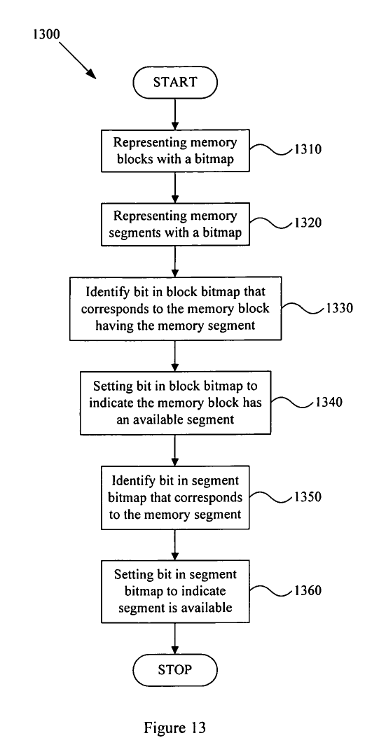

FIG. 12 illustrated an exemplary memory segment allocation method 1200, in accordance with various aspects of the present invention. For further understanding, FIG. 13 illustrates a method 1300 for utilizing a bitmap-based free-pointer-pool for memory de-allocation (or freeing) in accordance with various aspects of the present invention. As mentioned in the discussion regarding FIG. 12, the memory freeing method 1300 includes parsing the managed memory into blocks of memory segments. The method 1300 includes representing memory blocks 1310 with block flags and representing memory segments 1320 with segment flags.

In the illustrated memory-freeing method 1300, the address of the memory segment to be freed is known. The method 1300 includes a step 1330 that determines the block bit that corresponds to the memory block containing the designated memory segment. For example, the block-bit-determining sub-step 1330 may include converting a most significant portion of the memory segment address (i.e., the address of the memory block containing the memory segment) to the position of the corresponding block bit in the block bitmap.

Once the block bit determining step 1330 determines the appropriate block flag, the method 1300, in step 1340, sets the state of the block bit to indicate that the block corresponding to the block bit contains an available memory segment. Depending on the particular flag implementation, it may be most efficient to set the state of the block bit to the desired state, rather than determine whether the block bit already has the desired state prior to setting the bit state.

The method 1300 further includes a step 1350 that determines the segment bit that corresponds to the memory segment being freed. For example, the segment-bit-determining step 1350 may include converting the memory segment address to an index into the set of segment flags.

Once the method 1300 has identified, in step 1350, the segment flag corresponding to the memory segment being freed, the method 1300 may, at step 1360, set the segment flag to a state indicative of the designated segment being available for data storage.

In summary, a system, apparatus and method are provided for an apparatus and method for managing memory. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A memory management circuit for managing a memory having a plurality of memory blocks, each memory block having a plurality of memory segments, the memory management circuit comprising:
a first logic circuit associated with a first memory block of the plurality of memory blocks, the first logic circuit having a first state when the first memory block has a memory segment that is available for data storage and a second state when the first memory block does not have a memory segment that is available for data storage.

2. The memory management circuit of claim 1, further comprising a second logic circuit associated with a first memory segment of the first memory block, the second logic circuit having a first state when the first memory segment is available for data storage and a second state when the first memory segment is not available for data storage.

3. The memory management circuit of claim 1, wherein the first state and second state are states of a single logic bit.

4. The memory management circuit of claim 1, wherein the first state includes at least a portion of a memory address of the first memory block.

5. The memory management circuit of claim 1, further comprising a second logic circuit having a plurality of logic sub-circuits, each logic sub-circuit corresponding to a respective one of the memory segments of the first memory block, each logic sub-circuit having a first state when its respective memory segment is available for data storage and a second state when its respective memory segment is not available for data storage.

6. The memory management circuit of claim 2, further comprising a third logic circuit having a state indicative of a memory address of the first memory segment.

7. The memory management circuit of claim 2, further comprising a third logic circuit that converts the first state of the first logic circuit and the first state of the second logic circuit to the memory address of the first memory segment.

8. The memory management circuit of claim 2, wherein the first and second states of the first logic circuit are states of a single logic bit and the first and second states of the second logic circuit are states of a single digital bit.

9. The memory management circuit of claim 2, wherein the first state of the first logic circuit is indicative of a memory address of the first memory block and the first state of the second logic circuit is indicative of a memory offset between the memory address of the first memory block and the memory address of the first memory segment.

10. A memory management circuit for managing a memory having a first and second memory block, each memory block having a first and second memory segment, the memory management circuit comprising:
a first logic circuit having a first state when any of the memory segments of the first memory block are available for data storage and a second state when none of the memory segments of the first memory block are available for storage; and
a second logic circuit having a first state when any of the memory segments of the second memory block are available for data storage and a second state when none of the memory segments of the second memory block are available for data storage.

11. The memory management circuit of claim 10, further comprising:
a third logic circuit having a first state when the first memory segment of the first memory block is available for data storage and a second state when the first memory segment of the first memory block is not available for data storage; and
a fourth logic circuit having a first state when the second memory segment of the first memory block is available for data storage and a second state when the second memory segment of the first memory block is not available for data storage.

12. The memory management circuit of claim 11, further comprising:
a fifth logic circuit having a first state when the first memory segment of the second memory block is available for data storage and a second state when the first memory segment of the second memory block is not available for data storage; and
a sixth logic circuit having a first state when the second memory segment of the second memory block is available for data storage and a second state when the second memory segment of the second memory block is not available for data storage.

13. A memory management system for managing a memory having a plurality of memory blocks, each memory block having a plurality of memory segments, the memory management system comprising:
a first bitmap having a sequence of bits, each bit of the first bitmap corresponding to a respective one of the plurality of memory blocks, each bit of the first bitmap having a first logic state if the bit's respective memory block has a memory segment that is available for data storage and a second logic state if the bit's respective memory block does not have a memory segment that is available for data storage; and
a second bitmap having a sequence of bits, each bit of the second bitmap corresponding to a respective one of the plurality of memory segments of the memory, each bit of the second bitmap having a first logic state if the bit's respective memory segment is available for data storage and a second logic state if the bit's respective memory segment is not available for data storage.

14. The memory management system of claim 13, further comprising a logic circuit that identifies a bit in the first bitmap having the first logic state.

15. The memory management system of claim 13, further comprising a logic circuit that identifies a memory block having a memory segment available for data storage by identifying a first bit in the first bitmap having a state indicative of the first bit's respective memory block having a memory segment available for data storage, and identifies a memory segment that is available for data storage by identifying a second bit in the second bitmap having a logic state indicative of the second bit's respective memory segment being available for data storage.

16. The memory management system of claim 15, wherein the logic circuit identifies the second bit in the second bitmap by analyzing only bits in the second bit map that correspond to memory segments in the identified memory block.

17. The memory management system of claim 15, wherein the logic circuit determines the address of the memory segment that is available for data storage by generating a most significant portion of the address according to the position of the first bit in the first bitmap sequence of bits, and generating a least significant portion of the address according to the position of the second bit in the second bitmap sequence of bits.

18. The memory management system of claim 13, further comprising a logic circuit that identifies a bit in the second bitmap corresponding to a memory segment that is available for data storage based on a least significant portion of the address of the memory segment, and sets the logic state of the identified bit in the second bitmap to indicate that the memory segment is available for data storage.

19. The memory management system of claim 18, wherein the logic circuit further identifies a bit in the first bitmap corresponding to a memory block that includes the memory segment based on a most significant portion of the address of the memory segment, and sets the logic state of the identified bit in the first bitmap to indicate that the memory block includes a memory segment that is available for data storage.

20. The memory management system of claim 13, further comprising a logic circuit that converts a most significant portion of a memory segment address to a bit position in the first bitmap sequence of bits.

21. The memory management system of claim 13, further comprising a logic circuit that converts a most significant portion of a memory segment address to a bit position in the first bitmap sequence of bits, and sets the bit located at the bit position in the first bitmap to a logic state indicative of the bit's respective memory block having at least one memory segment available for data storage.

22. The memory management system of claim 13, further comprising a logic circuit that converts a least significant portion of a memory segment address into a bit position in the second bitmap sequence of bits.

23. The memory management system of claim 13, further comprising a logic circuit that converts a least significant portion of a memory segment address into a bit position in the second bit map sequence of bits, and sets the bit located at the bit position in the second bit map to a logic state indicative of the bit's respective memory segment being available for data storage.

24. A method for managing memory, the method comprising:
analyzing a first flag to determine whether a block of memory segments includes a memory segment that is available for data storage; and
if the block of memory segments includes a memory segment that is available for data storage, identifying a memory segment in the block of memory segments that is available for data storage.

25. The method of claim 24, wherein identifying a memory segment in the block of memory segments that is available for data storage comprises analyzing a second flag to determine whether a particular memory segment in the block of memory segments is available for data storage.

26. The method of claim 24, wherein identifying a memory segment in the block of memory segments that is available for data storage comprises:
analyzing a second flag to determine whether a first memory segment in the block of memory segments is available for data storage;
if the first memory segment in the block of memory segments is available for data storage, determining the address of the first memory segment; and
if the first memory segment in the block of memory segments is not available for data storage, analyzing a third flag to determine whether a second memory segment in the block of memory segments is available for data storage.

27. The method of claim 26, wherein the first flag is a flag in an array of flags, and determining the address of the first memory segment comprises converting a position of the first flag in the array of flags to a most significant portion of the address of the first memory segment.

28. The method of claim 26, wherein the second flag is a flag in an array of flags, and determining the address of the first memory segment comprises converting a position of the second flag in the array of flags to a least significant portion of the address of the first memory segment.

29. The method of claim 26, wherein the second flag is a flag in an array of flags, and determining the address of the first memory segment comprises converting a position of the second flag in the array of flags to the address of the first memory segment.

30. The method of claim 24, wherein identifying a memory segment in the block of memory segments that is available for data storage comprises analyzing a set of flags, each flag corresponding to a respective memory segment in the block of memory segments, to identify a memory segment in the block of memory segments that is available for data storage.

31. The method of claim 24, further comprising:
if the block of memory segments does not include a memory segment that is available for data storage, analyzing a second flag to determine whether a second block of memory segments includes a memory segment that is available for data storage; and
if the second block of memory segments includes a memory segment that is available for data storage, identifying a memory segment in the second block of memory segments that is available for data storage.

32. A method for managing a memory, the memory having a plurality of memory blocks, each of the plurality of memory blocks having a plurality of memory segments, the method comprising:
representing each of the plurality of memory blocks with a respective bit in a first bitmap, the logic state of each respective bit in the first bitmap indicative of whether each bit's respective memory block has at least one memory segment that is available for data storage; and
representing each of the memory segments with a respective bit in a second bitmap, the logic state of each respective bit in the second bitmap indicative of whether each bit's respective memory segment is available for data storage.

33. The method of claim 32, further comprising identifying a memory block that has a memory segment available for data storage by locating a bit in the first bitmap that has a logic state indicative of the memory block having a memory segment available for data storage.

34. The method of claim 33, further comprising identifying a memory segment that is available for data storage by locating a bit in the second bitmap that has a logic state indicative of the memory segment being available for data storage.

35. The method of claim 34, wherein locating a bit in the second bitmap that has a logic state indicative of the memory segment being available for data storage comprises:
identifying the position of the bit in the first bitmap that corresponds to the identified memory block;
utilizing the position of the bit in the first bitmap to index to a location in the second bitmap at which the bits corresponding to the memory segments in the identified memory block are located; and
analyzing at least one of the bits corresponding to the memory segments in the identified memory block to identify a bit that has a logic state indicative of the bit's respective memory segment being available for data storage.

36. The method of claim 34, further comprising determining the memory address of the memory segment available for data storage by converting the position of the bit in the first bitmap to a most significant portion of the memory address, and converting the position of the bit in the second bitmap to a least significant portion of the memory address.

37. The method of claim 32, further comprising designating that a memory segment is available for data storage by determining a position of a bit in the first bitmap that corresponds to a memory block that includes the memory segment, and setting the bit in the first bitmap to a logic state indicative of the memory block having a memory segment available for data storage.

38. The method of claim 32, further comprising designating that a memory segment is available for data storage by determining a position of a bit in the second bitmap that corresponds to the memory segment, and setting the bit in the second bitmap to a logic state indicative of the memory segment being available for data storage.

39. The method of claim 37, further comprising designating that a memory segment is available for data storage by determining a position of a bit in the second bitmap that corresponds to the memory segment, and setting the bit in the second bitmap to a logic state indicative of the memory segment being available for data storage.

40. The method of claim 37, wherein determining a position of a bit in the first bitmap comprises converting a most significant portion of the memory address of the memory segment into the position of the bit in the first bitmap.
